(19) United States
(12) Patent Application Publication
(10) Pub. No.: US 2021/0076725 A1
(43) Pub. Date: Mar. 18, 2021

(54) PLANT-BASED TODDLER NUTRITION PRODUCTS AND METHODS

(71) Applicant: Fat Baby Ltd., Hong Kong (CN)

(72) Inventors: Keswara Rao Vadlamani, Marlton, NJ (US); Nagendra Rangavajla, Dublin, OH (US); Shelley Davies, Hong Kong (CN)

(21) Appl. No.: 17/021,687

(22) Filed: Sep. 15, 2020

Related U.S. Application Data
(60) Provisional application No. 62/901,067, filed on Sep. 16, 2019.

(51) Int. Cl. A23L 33/185; A23L 33/175; A23L 33/12; A23L 33/125; A23L 33/16; A23L 33/15; A23L 33/135; A23L 33/00

(52) U.S. Cl. CPC A23L 33/185; A23L 33/175; A23L 33/12; A23L 33/125; A23V 2002/00; A23L 33/15; A23L 33/135; A23L 33/40; A23L 33/16

(57) ABSTRACT

Embodiments herein include non-allergenic plant-based complete protein toddler nutrition formulations and related methods. In an embodiment, a toddler nutrition composition is included having a selective group of non-allergenic legume proteins with 60-90% protein content, a selective group of non-allergenic cereal proteins containing 60-90% protein content. Embodiments herein can include combining a legume protein(s) and a cereal protein(s) in specific ratio (3:2 to 4:1) to create a complementary complete protein matrix providing all essential amino acids. In an embodiment, a method of manufacturing plant-based toddler nutrition product can include hydrating the complementary plant protein matrix, adding fat blend from a select group of non-allergenic plant sources, homogenizing to create a stable protein-fat emulsion, adding plant-based carbohydrate source, adding other minor nutrients (vitamins, minerals, probiotics), pasteurizing the mixture to kill pathogens, and spray drying. Other embodiments are also included herein.

This application claims the benefit of U.S. Provisional Application No. 62/901,067, filed Sep. 16, 2019, the content of which is herein incorporated by reference in its entirety.

### FIELD

Embodiments herein relate to plant-based toddler nutrition compositions and methods of making the same.

### BACKGROUND

Every year, approximately, 32 million Americans suffer from food allergies, including 5.6 million children under 18. About 40% of children with food allergies are allergic to more than one food. The Centers for Disease Control and Prevention reports that, the prevalence of food allergy in children increased by 50% between 1997 and 2011. Childhood hospitalizations for food allergy tripled between the 1990s and the mid-2000s. Caring for food allergies cost U.S. families nearly $25 billion annually.

Cow's milk protein allergy (CMPA) has become a public health problem worldwide and affects the health of 8% of children. CMPA is the most common food allergy in early childhood with a prevalence of up to 3% in the first year of life. In general, soy allergy is not as common as CMPA and is prevalent up to 0.4% in young children.

The majority of commercial infant and toddler nutritional formulas are based on milk protein. A limited number of products are based on soy protein. Unfortunately, infants and toddlers who are allergic to these milk/soy-based formulations do not get needed daily nutrition. Further, currently available products that are intended for allergic children are typically protein hydrolysate-based products. The protein hydrolysis process introduces significant bitterness and renders the product unacceptable for a young child causing consumption compliance issues affecting the child's nutritional status. Therefore, there is a need in the marketplace for products that address these allergen issues, and yet provide a nutritional and great tasting product.

### SUMMARY

Embodiments herein include a plant-based toddler nutrition composition including a plant protein blend including a legume protein with 60-90% protein content and a cereal protein with 60-90% protein content.

In an embodiment, a non-allergenic plant-based toddler nutrition product is included. The plant-based toddler nutrition product can include a complementary plant-based protein composition including a plant protein blend having a legume protein with 60-90% protein content and a cereal protein with 60-90% protein content.

In an embodiment, a method of making a shelf-stable plant-based toddle nutrition product is included. The method can include mixing plant proteins in specific ratios to form a complementary plant-protein blend. The plant-based toddler nutrition composition can include a plant protein blend including a legume protein with 60-90% protein content, and a cereal protein with 60-90% protein content. The method can also include hydrating the plant protein blend, mixing the hydrated plant protein blend with a plant-based fat blend and homogenizing to forming a stable protein-fat emulsion, then adding plant-based carbohydrates, minor nutrients and drying to a finished product.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following FIGURES (FIGS.), in which:

FIG. 1 is a flow chart of a process for producing a plant-based toddler nutrition product in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

As referenced above, the market for toddler nutrition formulations is quite substantial. However, there are limited non-allergenic toddler nutrition products in the marketplace. As such, there is a substantial unmet need in the industry for non-allergenic toddler nutrition formulations that provide complete plant-protein nutrition with all 9 essential amino acids with great taste, and great texture.

Embodiments herein include identifying and selecting a group of plant-proteins from a variety of sources with a specific chemical makeup (protein content) and specific functional properties and then combining those proteins in unique proportions to deliver on targeted functionality (good color, clean flavor, creamy mouthfeel, no-astringency/mouth drying).

A formulation including a complementary plant-protein composition delivering all essential amino acids is highly advantageous. However, legume proteins such as pea, mungbean, chickpea, lentil are generally deficient in sulfur containing (methionine, cysteine) essential amino acids. Cereal proteins such as rice, oats, barley, corn, millets are generally deficient in essential amino acid lysine. Therefore, legume proteins and cereal proteins are complementary. Thus, by combining legume protein with cereal protein, a complementary complete protein blend can be formed delivering all 9 essential amino acids.

As used herein, the term “shelf stable” with reference to a toddler nutrition product is defined as a toddler formula that is packed under normal packaging conditions and can be stored at room temperature for at least 180 days.

### Bulk Properties

Compositions herein can be formulated as a dry powder, as an aqueous solution/mixture at a concentration for consumer consumption such as a ready-to-eat (RTE) formulation, as an aqueous concentrate, and the like. In various embodiments, aqueous forms can have a water content of about 20, 30, 40, 50, 60, 70, 80, 90, or 95 percent water by weight, or an amount of water falling within a range between any of the foregoing. Conversely, aqueous forms can have a solids concentration of about 5, 10, 20, 30, 40, 50, 60, 70, or 80 percent by weight.

Compositions herein can have various pH values. In some embodiments, the composition can be formulated as low-acid beverage with a pH value of 6.5 or above. In some embodiments, the composition can be formulated as a high-acid beverage, with a pH value of 4.6 or below. In other embodiments, the pH value can be neutral or alkaline. In some embodiments, the pH value can be about 3.5, 4, 4.5, 5, 5.5, 6, 6.5, 7, 7.5, or 8, or can have a pH value falling within a range between any of the foregoing.

Viscosities of compositions herein can vary. In some embodiments, aqueous compositions herein can have a viscosity of about 2, 4, 6, 8, 10, or 12 mPa-s at 37 degrees Celsius and a shear rate of 5000/s (or a viscosity falling within a range between any of the forgoing).

### Plant Proteins

As applied to plant-based toddler nutrition product embodiments, the complementary plant-protein blend is selected to have about 60, 65, 70, 75, or 80 percent by weight of legume protein and 20, 25, 30, 35, 40% cereal protein. The complementary plant-protein blend can have a range of legume protein content and cereal protein content, wherein any of the foregoing percentages can serve as the upper or lower bound of the range, provided that the upper bound is larger than the lower bound. In some embodiments, the complementary plant protein blend can have an amount of protein from about 60 to 90%. In some embodiments, the complementary plant protein blend can have an amount of protein from about 70 to 80%.

As applied to plant-based toddler nutrition product embodiments, the components of the plant protein blend can be selected to have a specific ratio of legume to cereal proteins. In some embodiments, the range can be from 3:2 to 4:1. In some embodiments, the range can be from 3:1 to 2:1.

### Complementary Plant-Protein Composition

Legume proteins such as pea, mungbean, chickpea, lentil are generally deficient in sulfur containing essential amino acids (methionine, cysteine). Cereal proteins such as rice, oats, barley, corn, millets are generally deficient in essential amino acid lysine. By combining a legume protein (such as pea) with a cereal protein (such as rice) in specific ratio, a complementary complete plant-protein is created, delivering all 9 essential amino acids for growth.

Embodiments of complementary plant-protein blend herein can include a legume protein component and a cereal protein component.

Embodiments of methods of making complementary plant-protein blend can include: selecting sources of legume protein and cereal protein and combining them in unique proportions to deliver all 9 essential amino acids.

Embodiments herein for the plant-based toddler nutrition composition include a complementary plant-protein blend comprising from a selective group of plant proteins: (a) a legume protein with 60-90% protein content and (b) a cereal protein with 60-90% protein content.

In an embodiment, the legume protein content can be about 60%, 65%, 70%, 75%, or 80% of the total complementary plant-protein composition. In various embodiments, the legume protein content can be in a range wherein any of the foregoing percentages can serve as the upper or lower bound of the range, provided that the upper bound is greater than the lower bound.

In various embodiments, the cereal protein content can be about 20%, 25%, 30%, 35%, or 40% of the total complementary plant-protein composition. In some embodiments, the cereal protein content can be in a range wherein any of the foregoing numbers can serve as the upper or lower bound of the range.

In an embodiment, the complementary plant-protein blend can be about 10%, 15%, 20%, or 25% of the total plant-based toddler nutrition composition. In some embodiments, the complementary plant-protein blend content can be in a range wherein any of the foregoing numbers can serve as the upper or lower bound of the range, provided that the upper bound in greater than the lower bound.

### Plant-Based Fat Blend

Human breast milk contains ideal fatty acid profile for the growth of infants and toddlers. The breast milk fat content varies from 2.9-3.1 wt. % fat, having a fatty acid profile of 40% saturated fat, 45% monounsaturated fat, and 15% polyunsaturated fat.

Embodiments of plant-based fat blend herein can include a tree nut oil with 50-90% saturated fat, an oilseed oil with monounsaturated fat content of 70-85%, oils with omega fatty acid content of 40-50%; combined in specific ratio to mimic fatty acid profile of human breast milk.

In an embodiment, the tree nut oil content can be 40%, 45%, 50%, 55%, 60%, 65%, 70%, of the total plant-fat composition. In various embodiments, the tree nut oil content can be in a range wherein any of the foregoing percentages can serve as the upper or lower bound of the range, provided that the upper bound is greater than the lower bound.

In an embodiment, the oilseed oil content can be 30%, 35%, 40%, 45%, 50%, 55%, 60%, of the total plant-fat composition. In various embodiments, the oilseed oil content can be in a range wherein any of the foregoing percentages can serve as the upper or lower bound of the range, provided that the upper bound is greater than the lower bound.

### Other Components:

Other components of exemplary non-allergenic plant-based toddler nutrition compositions herein, can include, but are not limited to:

Plant-based fat ingredients including such as palm oil, sunflower oil, safflower oil, olive oil, canola oil, flax seed oil, algal oil, or combination thereof.

Plant-based carbohydrates including, but not limited to, maltodextrins, starches, rice syrup solids, malt syrup, grain syrups such as sorghum syrup etc.

Other optional ingredients including but not limited to vitamins, minerals, probiotics and natural flavors.

### Methods of Producing Plant-Based Toddler Nutrition Products:

Included herein are the methods of making plant-based toddler nutrition products, including but not limited to toddler nutrition formulations.

In some embodiments of plant-based toddler nutrition product, a step of selecting specific plant-protein ingredients and combining them in desired proportion to a target of all 9 essential amino acids can be included. The method can include further combining complementary plant-protein blend with other ingredients to form plant-based toddler nutrition formulation.

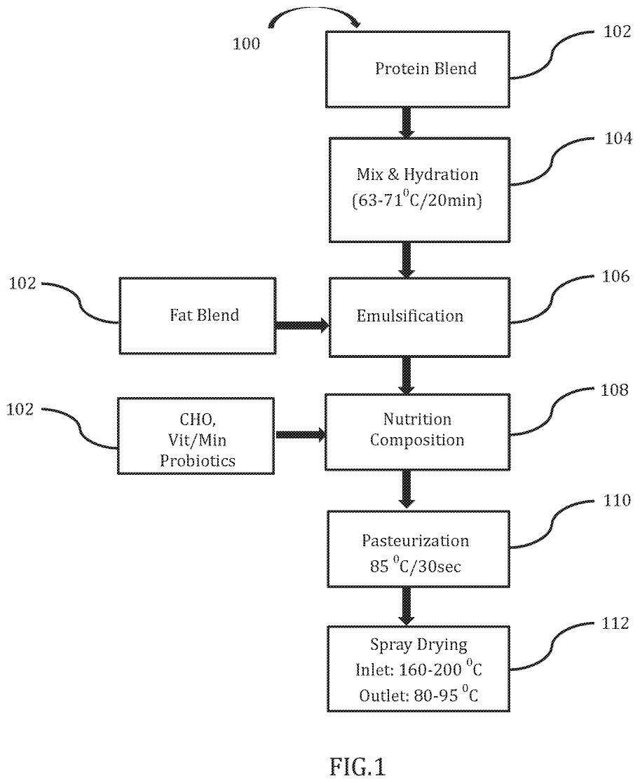

Aspects of a method 100 for making a plant-based toddler nutrition product in accordance with various embodiments herein are shown in the flow chart of FIG. 1. The method of making a plant-based toddler nutrition product can include an operation of obtaining ingredients 102 (as described herein). The ingredients can then be mixed 104 in another operation. In various embodiments, the mixing can occur in stages. By way of example, in some embodiments, there can be a first stage of mixing and hydration. The first stage of mixing can include the premixing of plant protein ingredients. The first step of hydration further includes addition of hot water (63 to 71° C.) and mixing at a high shear for 15-20 minutes until plant proteins are completely hydrated. The completeness of hydration is evaluated by absence of any fisheyes (un-hydrated particles), observed on a sieve.

In some embodiments, components added herein as dry matter can be selected to have a specific particle size and/or particle size range. By way of example, in some embodiments, plant protein ingredients herein can be initially obtained as a particulate having an average particle size of about 10 microns to about 50 microns.

In some embodiments, the method can include an operation of emulsification of plant-based fats with hydrated plant-protein blend 106. During the process of emulsification 106, the plant-based fat blend of 20-35 wt. % can included in the formulation. The protein-fat can be mixed at high shear and then homogenized at 500/2500 PSI to form stable protein-fat emulsion. The droplet size of the emulsion can be under <5 um size.

In some embodiments, the method of making the plant-based toddler nutrition product can also include an operation of combining additional ingredients such as plant-based carbohydrates, vitamins and minerals and probiotics and flavors, to complete the nutrition composition 108.

In some embodiments, the method of making the plant-based toddler nutrition product can include an operation of pasteurization 110. During the process of pasteurization 110, can include heating the product to a temperature of up to 85° C. and holding up to for 30-60 seconds.

In some embodiments, the method of making the plant-based toddler nutrition product can also include an operation of drying, such as spray drying 112. During the process of spray drying 110, can include drying the plant-based toddler nutrition product at inlet temperatures of about 160, 180, 200° C. (or in a range between any of the foregoing temperatures), for about 1, 2, 3, 5 seconds (or in a range between any of the foregoing times) and outlet temperatures of 80, 85, 90, 95° C. (or in a range between any of the foregoing temperatures).

However, it will be appreciated that in some embodiments a drying operation may be omitted, such as in the case of products herein prepared as aqueous compositions including, but not limited to, RTE (ready-to-eat) formulations.

In some embodiments, plant-based toddler nutrition product can be disposed within a package, such as a metal can, a plastic tub, a bottle, a jar, and the like.

### Further Embodiments

Embodiments herein include plant-based toddler nutrition compositions and methods for making shelf stable non-allergenic plant-based toddler nutrition products.

In an embodiment, the plant-based toddler composition consists of a plant-protein blend comprising from a selective group of proteins (a) a legume protein with 60-90% protein content, (b) a cereal protein with 60-90% protein content.

In an embodiment, the plant protein components are blended in desired proportions to a target legume:cereal protein ratio of 3:1 or 2.1.

In an embodiment of the ‘plant-based toddler nutrition composition”, the legume protein content varied from 60-80% and cereal protein content from 20-40%.

In an embodiment, the legume protein used in the “plant-based toddler nutrition” can be from a selective group: pea, mungbean, favabean, chickpea, black-eyed pea, lentil and combination thereof.

In an embodiment, the preferred legume proteins are pea and mungbean.

In an embodiment, the cereal protein can be selected from the group of rice, oats, sorghum, millet and combination thereof.

In an embodiment, the preferred cereal protein is a rice protein.

In an embodiment, the plant-based fat blend can be a blend of palm oil, sunflower oil, rice bran oil, flax seed oil and algal oil or combination thereof.

In an embodiment, the other ingredients can include such as plant-based carbohydrates, vitamins, minerals, probiotics.

In an embodiment, the method involves hydrating plant-protein blend, adding plant-based fat blend and homogenizing to form a stable protein-fat emulsion, and adding other ingredients such as plant-based carbohydrates, vitamins and minerals and probiotics. The method includes further steps of pasteurization, and spray-drying to a finished dry product.

Aspects may be better understood with reference to the following examples. These examples are intended to be representative of specific embodiments, but not intended as limiting the overall scope of embodiments herein.

### EXAMPLES

### Example 1—Preparation of Non-Allergenic Complementary Plant-Protein Composition

In this example, the formulation of an exemplary complementary plant-protein composition delivering all essential amino acids was demonstrated. Legume proteins such as pea, mungbean, chickpea, lentil, are generally deficient in sulfur containing (methionine, cysteine) essential amino acids. Cereal proteins such as rice, oats, barley, corn, millets are generally deficient in essential amino acid lysine. By combining legume protein (ex. pea) with cereal protein (ex. rice) in specific ratio (75:25), a complementary complete protein is created delivering all 9 essential amino acids, similar to a reference protein.

| | | | | Pea-Rice |
|---|---|---|---|---|
| | | | | Protein |
| | Reference | Pea | Rice | Blend |
| | Protein | Protein | Protein | (75:25) |
| Essential AA | (mg/g) | (mg/g) | (mg/g) | (mg/g) |
| Histidine | 18 | 26 | 22 | 25 |
| Isoleucine | 25 | 42 | 44 | 43 |
| Leucine | 55 | 79 | 80 | 79 |
| Lysine | 51 | 78 | 27 | 65 |
| Methionine + Cysteine | 25 | 24 | 50 | 31 |
| Phenylalanine + Tyrosine | 47 | 82 | 133 | 95 |
| Threonine | 27 | 41 | 36 | 40 |
| Tryptophan | 7 | 9 | 14 | 10 |
| Valine | 32 | 47 | 58 | 50 |

### Example 2—Preparation of Plant-Protein Based Toddler Nutrition Composition

In this example, a plant-protein based toddler nutrition formula including a non-allergenic complementary plant-protein composition was prepared. The complementary plant protein blend used included pea protein and rice protein ingredients combined in specific 4:1 ratio to provide all 9 essential amino acids. Optional ingredients in the formulation included: an oil blend from select plant sources, a carbohydrate blend, vitamins and minerals, probiotics, natural flavor and water. The ingredients were mixed and processed as described in FIG. 1.

| | % by |
|---|---|
| Toddler Nutrition Product Composition | Weight |
| Plant-based Protein Blend (Pea/Rice) | 20-25 |
| Plant-based Fat Blend (Palm, Sunflower, | 20-25 |
| Ricebran, Flax, Algal Oils) | |
| Plant-based Carbohydrate Blend | 45-50 |
| Micronutrients (vitamins/minerals, | 4-6 |
| probiotics etc) | |

### Example 3—Preparation of Plant-Protein Based Toddler Nutrition Composition

In this example, a plant-protein based toddler nutrition formula was non-allergenic complementary plant-based protein composition is shown. In this example, the complementary plant protein blend used includes mungbean protein and rice protein ingredients combined in specific 2:1 ratio to provide all 9 essential amino acids. Optional ingredients in the formulation include: an oil blend from select plant sources, a carbohydrate blend, vitamins and minerals, probiotics, natural flavor and water. The ingredients were mixed and processed as described in FIG. 1.

| | % by |
|---|---|
| Toddler Nutrition Product Composition | Weight |
| Plant-based Protein Blend (Mungbean/Rice) | 20-25 |
| Plant-based Fat Blend (Palm, Sunflower, | 20-25 |
| Ricebran, Algal Oils) | |
| Plant-based Carbohydrate Blend | 45-50 |
| Micronutrients (vitamins/minerals, | 4-6 |
| probiotics etc) | |

### Example 4—Sensory Evaluation of Plant-Protein Based Toddler Nutrition Compositions

In this example, plant-based toddler formulations herein (example 2 and 3) were evaluated against commercial toddler formulations (ENFAGROW, SIMILAC, NATURE'S ONE) for sensory performance. Overall acceptability was scored on a hedonic scale of 1-7. The results are shown in the table below. This example shows that plant-based formulations of embodiments herein (Examples 2 and 3) were superior in taste, texture, and overall acceptability.

| | | | | | | | Overall |
|---|---|---|---|---|---|---|---|
| Product | Protein | Color | Flavor | Sweetness | Texture | Aftertaste | Acceptance |
| ENFAGROW | Dairy | White | Vanilla | Sweeter | Watery, | Mouth | 6 |
| | | | Cream, | than | Skim milk | drying | |
| | | | Vitamin | regular | mouthfeel | | |
| | | | mineral taste | milk | | | |
| SIMILAC | Soy | Off | Strong Fishy | As sweet | Good | Slightly | 2 |
| | | White | Tastes bad | as | body and | chalky | |
| | | | | SIMILAC | mouthfeel | | |
| Baby's Only | Soy | Off | Fishy, | Less | Good | Astringent, | 2 |
| | | White | Tastes bad | Sweet | body and | Mouth | |
| | | | | | mouthfeel | drying | |
| Example 2 | Pea + | | No Fishy | Sweetness | Creamy, | Slightly | 6 |
| | Rice | | smell, | similar to | Good | chalky, no | |
| | | | Pleasant | ENFAGROW | body | Mouth | |
| | | | Taste, | | | drying | |
| | | | Cereal Taste | | | | |
| Example 3 | Mung + | Off | No Fishy | Sweetness | Less | Slightly | 6 |
| | Rice | White | smell, Bland | similar to | Creamy | chalky, | |
| | | | and Clean | ENFAGROW | | No Mouth | |
| | | | taste | | | drying | |

The 7-point hedonic scale includes:
7—Very much liked; 6—Liked a lot; 5—Liked; 4—Neither liked nor disliked; 3—Disliked; 2—Much disliked; 1—Very much disliked

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A plant-based toddler nutrition composition comprising:
a plant protein composition comprising
a legume protein component having 60-90 wt. % protein content;
a cereal protein component having 60-90 wt. % protein content;
the plant-based toddler nutrition composition comprising
histidine;
isoleucine;
leucine;
lysine;
methionine;
phenylalanine;
threonine;
tryptophan; and
valine.

2. The plant-based toddler nutrition composition of claim 1, wherein the legume protein component comprises 60 to 80 wt. % of the plant protein composition.

3. The plant-based toddler nutrition composition of claim 1, wherein the cereal protein component comprises 20 to 40 wt. % of the plant protein composition.

4. The plant-based toddler nutrition composition of claim 1, comprising a protein content of 13 to 21 wt. % based on the total weight of the plant-based toddler nutrition composition.

5. The plant-based toddler nutrition composition of claim 1, comprising a protein content of 16 to 21 wt. % based on the total weight of the plant-based toddler nutrition composition.

6. The plant-based toddler nutrition composition of claim 1, comprising a protein content of 19 to 21 wt. % based on the total weight of the plant-based toddler nutrition composition.

7. The plant-based toddler nutrition composition of claim 1, wherein the ratio of legume protein to cereal protein is about 3:2 to 4:1 weight/weight.

8. The plant-based toddler nutrition composition of claim 1, wherein the ratio of legume protein to cereal protein is about 3:1 to 2:1 weight/weight.

9. The plant-based toddler nutrition composition of claim 1, wherein the average protein digestibility for all protein in the nutrition composition is about 93-95%.

10. The plant-based toddler nutrition composition of claim 1, the legume protein component comprising one or more of pea, mungbean, fava, chickpea, black-eyed pea, lentil, or a combination thereof.

11. The plant-based toddler nutrition composition of claim 1, the cereal protein component comprising one or more of rice, oat, sorghum, millet, and combination thereof.

12. The plant-based toddler nutrition composition of claim 1, further comprising:
a plant-based fat blend comprising
a tree nut oil comprising a saturated fat content of 50-90 wt. %;
an oilseed oil comprising mono saturated fat content of 70-85 wt. %; and
an oil comprising omega fatty acid content of 40-50 wt. %.

13. The plant-based toddler nutrition composition of claim 12, the fat comprising one or more sources of high oleic sunflower oil, safflower oil, palm oil, palm kernel oil, ricebran oil, flaxseed oil, algae oil and a combination thereof.

14. The plant-based toddler nutrition composition of claim 12, the overall fat composition having a saturated fat content of 25-40 wt. %, 45-55 wt. % monounsaturated fat, and 10-20 wt % polyunsaturated fat of total fat content.

15. The plant-based toddler nutrition composition of claim 12, the protein matrix provides antioxidant benefit to extend shelf life (by 50%) and organoleptic attributes of the product.

16. The plant-based toddler nutrition composition of claim 12, the protein matrix delivers improved emulsification to enhance creaminess (by 50%) and sensory profile (50% better compared to competitive products).

17. The plant-based toddler nutrition composition of claim 1, wherein the pH of the composition is from 6.5 to 7.2.

18. A plant-based toddler nutrition product comprising:
a plant protein composition comprising
a complementary plant protein blend comprising
a legume protein with 60-90% protein content;
a cereal protein with 60-90% protein content:
the composition containing all 9 essential amino acids;
a plant-based fat blend composition comprising
a tree nut oil with saturated fat content of 50-90%;
an oil seed oil with monosaturated fat content of 70-85%; and
oils with omega fatty acid content of 40-50%.

19. The plant-based nutrition product of claim 18, wherein the reconstituted nutrition product has viscosity value of less than 20 cp.

20. A method of making a plant-based toddler nutrition product comprising:
hydrating a complementary plant-protein blend in hot water, the complementary protein composition comprising:
a legume protein with 60-90% protein content;
a cereal protein with 60-90% protein content
mixing plant-fat blend from select plant sources;
homogenizing to create a stable protein-fat emulsion complex;
adding carbohydrates, minor nutrients, and
spray drying the mixture to a finished product.
